(19) United States
(12) Patent Application Publication
(10) Pub. No.: US 2007/0124662 A1
(43) Pub. Date: May 31, 2007

(54) OFFLINE CLICK-THROUGH ADS WITHIN INTERNET CONTENT

(76) Inventors: Gary William Streuter, Foothill Ranch, CA (US); William Pat Price, Santa Ana, CA (US)

Correspondence Address: FISH & RICHARDSON, PC, P.O. BOX 1022, MINNEAPOLIS, MN, 55440-1022, US

(21) Appl. No.: 11/549,079

(22) Filed: Oct. 12, 2006

Related U.S. Application Data
(60) Provisional application No. 60/727,442, filed on Oct. 18, 2005.

(51) Int. Cl. G06F 17/00; G06F 17/30; G07G 1/14; G06F 15/16

(52) U.S. Cl. 715/500; 715/501.1; 705/14; 709/227; 707/1

(57) ABSTRACT

Offline advertising content is stored on a computer and displayed. The offline advertising content includes clickable links which allow offline click through to an advertiser's website. The user can click through even when the system is not connected to the Internet. The advertising content may be displayed in special panels that are formed as layers over the Internet content, and the panels may be set to transparent when no advertising content is present.

### CROSS-REFERENCE TO RELATED APPLICATION

This application claims priority to U.S. application Ser. No. 60/727,442, filed on Oct. 18, 2005. The disclosure of the prior application is considered part of (and is incorporated by reference in) the disclosure of this application.

### BACKGROUND

Internet websites often offer advertising as a way to finance their otherwise free services such as e-mail, photo storage, search engines, and other services. There is substantial competition among the websites to provide better services in order to attract the users to the particular portal sites. The portal sites often display commercial advertising when the user is online and connected. The portal sites collect a fee based on the advertising content. An additional fee may be collected if the user visits or clicks through to the content owner's website. Additional fees may be collected if the user actually purchases a product or service from that website.

### Summary

In all of these paradigms, if the user is not connected to the Internet, the user cannot view advertising content generated by the site and therefore cannot click through. The inventors recognize that this may deprive the portal of an opportunity to generate additional revenue.

According to an aspect, the present application describes caching Internet generated ads on a local storage device in a way that allows these ads to be displayed to a user while using your computer, even when the computer is offline, e.g., not connected to the Internet.

According to an embodiment, panels of advertising content are generated by a selected Internet site. This Internet generated content may be stored on a data storage device and displayed as embedded panels even when the user is offline.

In an embodiment, the panels may be layers that are displayed over the layers of Internet content.

### BRIEF DESCRIPTION OF THE DRAWINGS

FIG. 1 illustrates a computer system with a single ad panel;

FIG. 2 illustrates displaying multiple ad panels;

FIG. 3 shows a data storage device storing the content;

FIG. 4 illustrates the data storage device and computer storing offline content; and

FIG. 5 is a flowchart illustrating the operation.

### DETAILED DESCRIPTION

The present application describes advertising for displaying on an Internet display, the advertising being in special areas of the screen and/or application, referred to herein as panels. The software application that displays the Internet also displays the panels in a specified way, which may be any way that is currently used for displaying supplemental information, including frames or banners. Embodiments may include special frames, banners, graphics video or text, and/or audio. The advertising content may be periodically refreshed or changed, under control of the portal that provides the advertising content.

The software application also includes techniques which enable caching the Internet generated content to a data storage device that is contained within or connected to the user's computer system. Once cached, the advertising content is still displayed on the panels. The user may click through to the cached content, opening an occurrence of a Web browser to complete the connection to the desired site or to display an offline version of the desired site. The operation of opening the web browser may embed a code that allows later accessing of the site, if the user is still offline. The operation may also count a new click-through credit for the portal, thereby providing additional revenue for the portal.

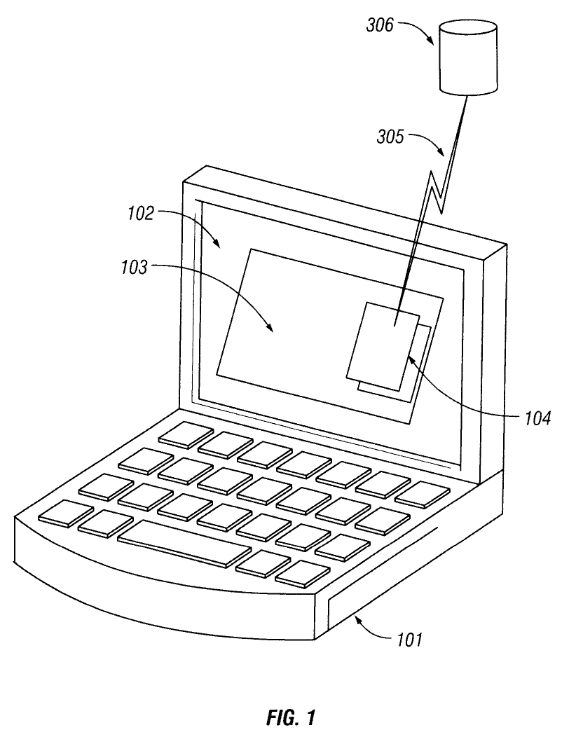

FIG. 1 illustrates a computer system 101, shown in FIG. 1 as a lap-top type computer. The viewing monitor 102 views the results of the information obtained from the Internet. An application 103 is shown being displayed on the display. The application 103 includes a panel 104 that displays advertising content within the application 103.

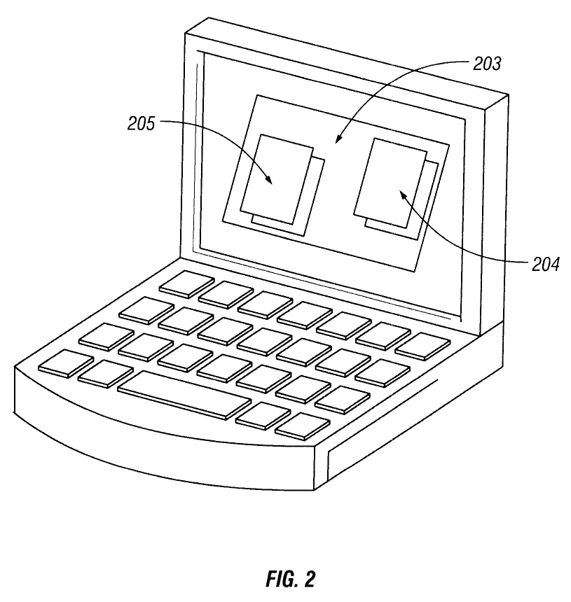

FIG. 2 illustrates displaying an application 203 which includes two separate panels 204,205 used to display advertising content within the application 203. It should analogously be understood that any number of panels can be displayed according to the embodiments, in any different location within the application or even outside the application. In one embodiment, special panels can be used as of the type illustrated in FIG. 1. These panels can be effectively parallelograms, that are located wholly within the display formed of the application, and can be located at any point within the application. In the example shown in FIG. 1, the parallelogram 104 is located at the edge of the window, but separated from the edge of the window by a border. The Internet content is displayed within that parallelogram.

According to another aspect, the parallelogram forms sides that are parallel to some portion of the perimeter of the application. The advertising content which is obtained is displayed within the panel.

According to another aspect, the panels are effectively layers, which are displayed over the layer that displays the Internet content. In the embodiment, the panels can obtain any color or no color at all. For example, if there is no advertising content that is currently being displayed or currently available, the layers may be set to either transparent or to the same color as the underlying application, so that the panels are effectively hidden.

According to another embodiment, the panel may be any conventional panel such as a frame, banner, or other area.

FIG. 1 also illustrates how the computer may include a link 105 to an Internet site shown as 106. This may provide the content to be displayed on the display.

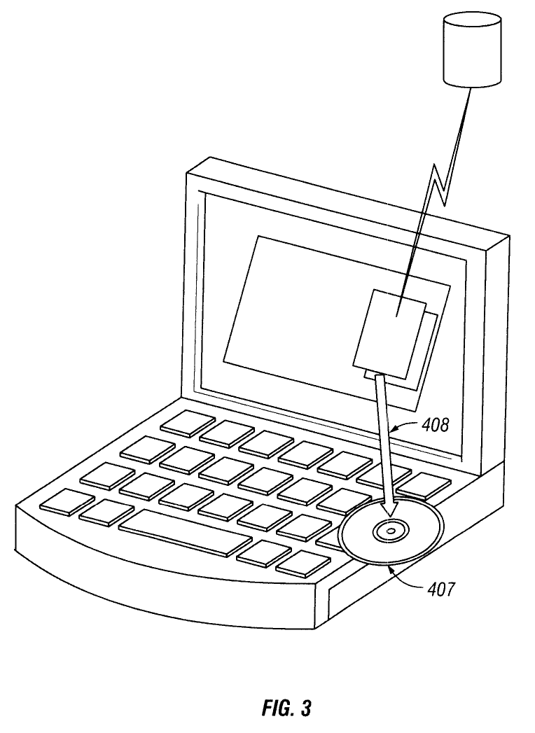

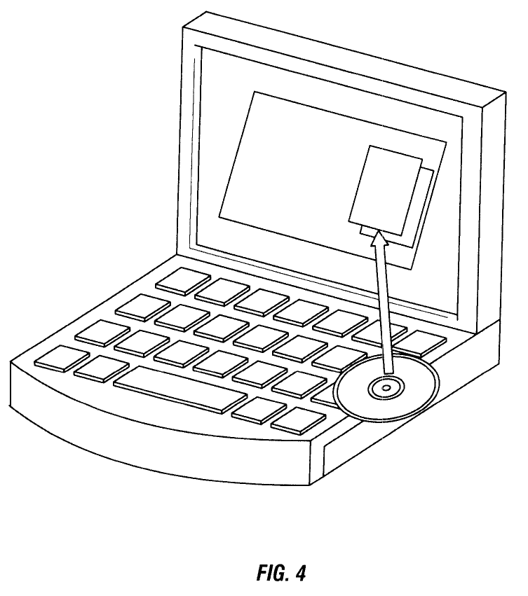

FIG. 3 shows a data storage device 407 that is embedded within the computer system, and which can provide offline storage of information. FIG. 4 illustrates the data storage device and computer storing offline content. In this embodiment, it is not connected to the Internet.

In operation, the computer may connect to the Internet to obtain advertising content. The cached advertising content is then stored on the data storage device.

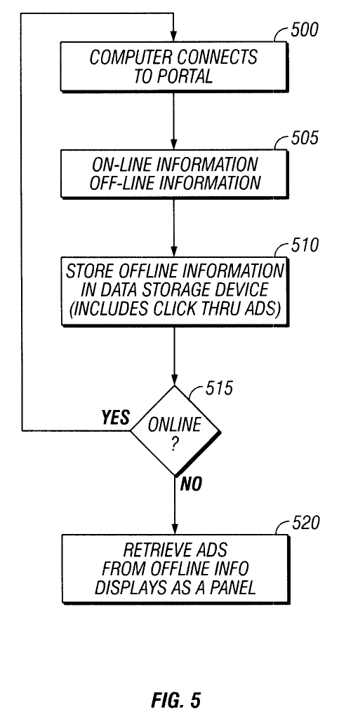

The operation proceeds according to the flowchart of FIG. 5. At 500, the computer connects to the portal. Upon connecting to the portal, the computer receives two different kinds of information at 505. The computer receives online information, which is intended to be displayed immediately, and is displayed immediately. The computer also receives, either as a lower priority, as a background process, or after receiving the online information, some offline information. The offline information is stored in the data storage device at 510. The offline information includes click through type ads which allow a user to select a link offline. Based on the selection of that link, the user is allowed to click through to an advertiser's website. 515 illustrates a decision which may be carried out at any time during the operation of the computer, a determination if the computer is currently online. If so, control passes to 500, where the computer connects to the portal. If not, however, control passes to 520, where the computer retrieves the ads from the offline in a cache, and displays that as a panel within parts of other offline information.

The cached advertising material can be stored in any kind of data storage device that is within or attached to the user's computer system. Exemplary storage devices may include hard drives, optical drives, and solid-state drives or memories. In addition, the click-through described above may cause an automatic connection to the Internet, or may provide a bookmark type signal for use during later connections to the Internet. Another aspect allows the panels to be any size, including larger than the display format on the computer screen. In this latter case, horizontal and vertical scroll mechanisms may be used to view the panels.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of panels can be used to display the offline information.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A method, comprising:
while connected to the Internet, obtaining online information to be displayed in real-time, and offline information to be displayed at some time other than a current time, the offline information including advertisements and including offline links within the advertisements that allow clicking through to an advertiser's website;
displaying said online information when the user is connected to the Internet; and
displaying offline information including said offline advertising information and said offline links, when the user is could not connected to the Internet.

2. A method as in claim 1, wherein said displaying comprises displaying advertising content within special panels that are wholly within a display location of the Internet site.

3. A method as in claim 1, wherein said displaying comprises displaying the advertising content in a panel which forms a base layer that is separate from a layer that displays the Internet content.

4. A method as in claim 3, further comprising determining if advertising content is present, setting a color of the layer to a viewable color when advertising content is present, and setting the color of the layer to a non-viewable color when advertising is not present.

5. A method as in claim 4, wherein said setting the color of the layer to the non-viewable color comprises setting the layer to be transparent.

6. A method as in claim 1, further comprising, updating the offline information each time the computer connects to the Internet.

7. A method as in claim 1, wherein said offline information includes multiple different advertising content items.

8. A method as in claim 1, further comprising enabling occurrence of a Web browser and connection to an Internet site from said offline information.

9. A method, comprising:
obtaining information from an Internet site which includes both Internet content and advertisements;
displaying the Internet content on a first layer on a display screen; and
displaying the advertisements on a second layer, that is over said first layer, on said display screen.

10. A method as in claim 9, wherein said second layer has a viewing characteristic that is separately controlled from a viewing characteristic of said first layer.

11. A method as in claim 10, wherein further comprising determining whether advertising content is available, setting the second layer to a viewable state when said advertising content is available, and setting the second layer to a non-viewable state when said Internet content is not available.

12. A method as in claim 11, wherein said non-viewable state is a transparent state.

13. A method as in claim 9, wherein said obtaining comprises obtaining both online information and offline information from the Internet site, and where said offline information includes offline advertising content that includes links to websites of advertisers.

14. A method as in claim 13, wherein said obtaining further comprises updating offline information in an existing cache of offline information, including at least updating offline information of advertisers.

15. A computer system, comprising:
a processor with a Web browser running on said processor, and a memory storage unit, said Web browser accessing an Internet site to obtain both online and offline Internet content, displaying the online Internet content when the user Web browser is connected to the Internet, and displaying the offline Web content when the Web browser is not connected to the Internet, wherein the offline Web content includes both Internet content and advertisements, and said offline Web content further includes clickable ads within the advertisement that can be used to open a web browser window to the subject of the Internet ads.

16. A computer system as in claim 15, wherein said Web browser includes a first layer that displays the Internet content, and a second layer that displays advertising, said second layer being displayed over said first layer.

17. A computer system as in claim 16, wherein said second layer is displayed in a viewable color when advertising content is present, and is displayed in a transparent way when advertising content is not present.
